(19) United States
(12) Patent Application Publication
(10) Pub. No.: US 2012/0039710 A1
(43) Pub. Date: Feb. 16, 2012

(54) INTERMEDIATE CASING OF AIRCRAFT TURBOMACHINE INCLUDING STRUCTURAL CONNECTING ARMS WHICH PERFORM SEPARATE MECHANICAL AND AERODYNAMIC FUNCTIONS

(75) Inventors: Frederic Marius Mathieu, Corbeil Essonnes (FR); Thierry Georges, Paul Papin, Varennes-Jarcy (FR)

(73) Assignee: Snecma, Paris (FR)

(21) Appl. No.: 13/265,056

(22) PCT Filed: Apr. 21, 2010
(86) PCT No.: PCT/EP2010/055262

§ 371 Date: Oct. 18, 2011

(30) Foreign Application Priority Data
Apr. 22, 2009 (FR) 0952626

(51) Int. Cl. F01D 25/28; B23P 15/00

(52) U.S. Cl. 415/213.1; 29/888.02

(57) ABSTRACT

A structural connecting arm for an intermediate casing of an aircraft turbomachine with a ducted fan, wherein the arm is configured to connect a hub and an outer ferrule of the casing, and including an aerodynamic outer surface manufactured such that the arm also forms an outlet guide vane. Multiple metal ties extend in the longitudinal direction of the arm, together with a shell made from composite material surrounding the ties and forming the aerodynamic outer surface.

### TECHNICAL FIELD

The present invention relates in a general sense to the field of turbomachines with ducted fan for aircraft, and more specifically to the intermediate casings fitted to these turbomachines.

The invention preferably applies to turbomachines of the turbofan for aircraft type.

### STATE OF THE PRIOR ART

In existing turbojets, of “ducted fan” design, there is generally a fan casing extended to the rear by an intermediate casing, which is attached to it securely. This intermediate casing includes a hub and an outer ferrule positioned concentrically, and connected to one another by structural connecting arms, distributed in the circumferential direction and habitually extending in the turbojet's radial direction.

The structural arms therefore have a high mechanical resistance allowing the efforts to be transmitted between the outer ferrule and the hub of the intermediate casing, which is generally located in line with a forward rolling bearing of the turbojet. In addition to the transfer of the efforts, these arms must be able to resist the projectiles likely to impact them.

These arms are habitually located downstream from multiple outlet guide vanes, also called OGVs, the function of which is to straighten the secondary airflow escaping from the fan, in order to limit its whirling. In such a case, the outlet guide vanes are located in the secondary annular channel of the turbojet and are supported by the fan casing, upstream from the structural arms.

To simplify the design of such a turbojet it has been proposed to incorporate the function of the outlet guide vanes within the structural connecting arms, so as to allow the former to be eliminated. To accomplish this each structural arm has an aerodynamic outer surface performing this role of straightener of the flow escaping from the fan.

Despite this simplification, such structural arms continue to have a substantial total mass, due to the fact that they generally consist of solid metal elements, which additionally leads to high material costs. In addition, since the aerodynamic outer surface of these solid metal elements must be machined precisely, production costs also reach high levels.

### SUMMARY OF THE INVENTION

The purpose of the invention is therefore to provide at least partially a solution to the disadvantages mentioned above, compared with the embodiments of the prior art.

To accomplish this, a first object of the invention is a structural connecting arm for an intermediate casing of a turbomachine with ducted fan, where the arm is intended to connect a hub and an outer ferrule of this intermediate casing, and having an aerodynamic outer surface produced such that the arm also forms an outlet guide vane.

According to the invention, it includes multiple metal ties extending in the longitudinal direction of the arm, together with a shell made from composite material surrounding the said ties and forming the said aerodynamic outer surface. In addition, at least a part of an inner space demarcated by the shell and traversed by the ties is filled by a filling material forming a support of the said shell.

Thus, the invention is remarkable in that it involves an arm with dissociated elements in order to perform, respectively, the aerodynamic function of the flow straightener, and that of mechanical resistance.

Indeed, the mechanical resistance required to transfer the efforts between the outer ferrule and the hub of the intermediate casing, and for the resistance of the arm to the impacts of projectiles, is performed by the metal ties, whereas the aerodynamic function is performed by the shell of composite material, preferably of the type of a blend of glass and/or carbon fibres with a resin, for example of the epoxy resin type.

This results, firstly, in a gain in terms of total mass, particularly due to the presence of the composite material shell, the location of which within a structural part of a turbomachine is one of the original features of the present invention. The mass reduction has been assessed at between 25% and 35% compared to the known solution with solid metal elements, described above.

Moreover, the proposed solution advantageously leads to reduced materials and production costs compared to those found hitherto.

In addition, as mentioned above, at least a part of an inner space demarcated by the shell and traversed by the ties is filled by a filling material forming a support of the said shell. This enables the manufacture of the shell to be facilitated, and this shell can then be cast on this filling material, which acts as its support, and the latter may also possibly include the ties.

Each tie is preferably separated from the composite material shell by the said filling material. Consequently, in this case, it is arranged such that the ties are not in direct contact with the shell, for various reasons. The first lies in the desire to improve the support of the shell for its manufacture, incorporating a uniform support surface, consisting of an alternation between the filling material and the ties, which could subsequently lead to incipient cracks, or other faults. The second reason lies in the desire to obtain a structural arm the possible vibrations of the ties of which can be dampened by the filling material, and therefore not be transferred directly to the aerodynamic shell. The risks of floating of the latter are greatly and advantageously reduced thereby, with the positive consequences which this has for the thrust performance generated by the secondary flow.

To accomplish this, it is, for example, arranged such that each tie is sunk in the said filling material along the entire length of the shell, that is to say along the segment corresponding to the length of the shell, having a lateral surface which is completely covered by the filling material.

Each tie preferably extends, in the longitudinal direction of the arm, beyond the said shell, either side of the latter. Thus, the ends of the protruding ties can easily be used to assemble the arm on the outer ferrule and on the hub.

With this regard, it is arranged such that the said ties support at their radially outer ends means for attaching the arm on the outer ferrule of the intermediate casing, and support at their radially inner ends means for attaching the arm on the hub of the intermediate casing.

The said means for attaching the arm on the outer ferrule and the means for attaching the arm on the hub preferably each includes a bracket having holes for attaching the ties, and attachment holes for assembly on the outer ferrule and the hub, respectively.

Another object of the invention is an intermediate casing of a turbomachine with ducted fan, including multiple structural connecting arms such as the one described above, connecting the hub and the outer ferrule of this casing.

Finally, another object of the invention is a method for the assembly of such a structural connecting arm on an intermediate casing of a turbomachine with ducted fan, where the method includes the following steps:
positioning of the arm facing the annular space demarcated between the outer ferrule and the hub of the intermediate casing;
positioning of the arm between the outer ferrule and the hub of the intermediate casing, by moving the arm in the axial direction of the intermediate casing; and
attachment of the arm on the outer ferrule and on the hub of the intermediate casing.

This method is extremely easy to implement, since the arm is positioned simply by moving it in the axial direction of the intermediate casing, between the outer ferrule and the hub, which do not require to be moved. Moreover, the arm can equally easily be removed from the intermediate casing, during handling operations the purpose of which is, for example, to repair or exchange it, giving it the character of an item of equipment which can be replaced during a stopover, also called an LRU (Line Replaceable Unit).

Other advantages and characteristics of the invention will appear in the non-restrictive detailed disclosure below.

### BRIEF DESCRIPTION OF THE DRAWINGS

This description will be made with reference to the attached illustrations, among which:

FIG. 1 represents a longitudinal half-section view of a forward part of an aircraft turbojet according to a preferred embodiment of the present invention;

FIG. 2 represents a perspective view of a part of one of the structural connecting arms fitted to the intermediate casing of the turbojet shown in FIG. 1;

FIG. 3 represents a section view taken in plane P of FIG. 2;

FIGS. 4a and 4b shows diagrams of a method of manufacture of the arm shown in FIGS. 2 and 3;

FIG. 5 shows a perspective view of the arm represented in FIG. 2, fitted with its means for attachment to the elements of the intermediate casing;

FIG. 6 represents a section view of a radially inner part of the structural arm shown in the previous figures;

FIG. 7 represents a perspective view of a radially outer part of the structural arm shown in the previous figures;

FIG. 8 represents a perspective view of the structural arm shown in the previous figures, assembled on the hub and the outer ferrule of the intermediate casing;

FIG. 9 shows a diagram of a method of assembly of the structural connecting arm on the intermediate casing, according to a preferred embodiment of the invention; and

FIG. 10 shows a perspective view of the intermediate casing fitted to the turbojet shown in FIG. 1.

### DETAILED DESCRIPTION OF PREFERRED EMBODIMENTS

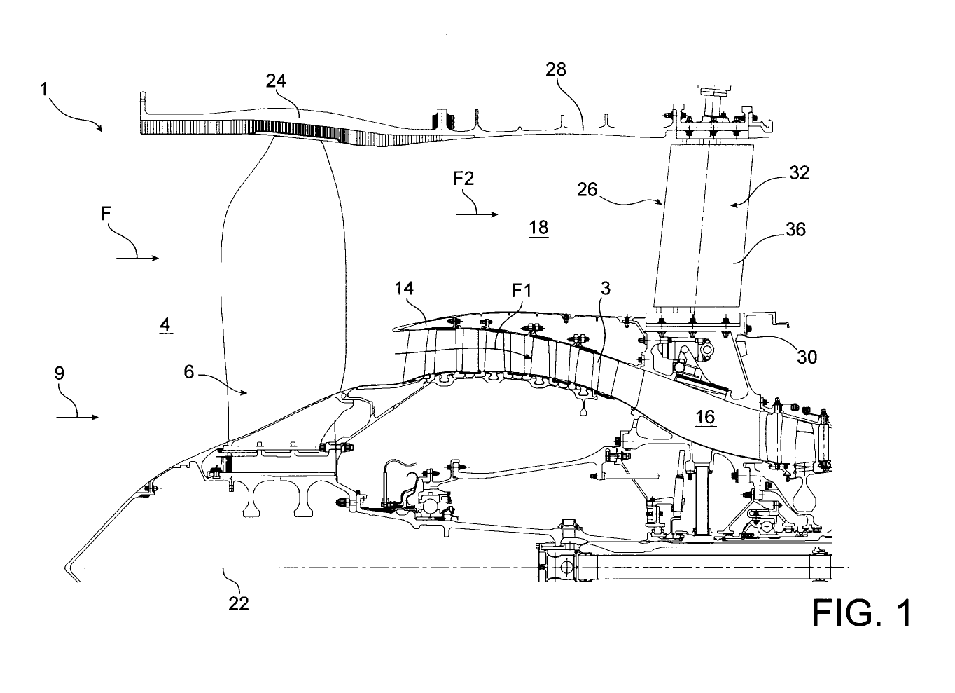

With reference to FIG. 1, a front part 1 of a turbofan for aircraft, according to a preferred embodiment of the present invention, can be seen.

In FIG. 1, only the low-pressure compressor 3 of the gas generator has been represented, which is, for example, a two-compressor generator.

The turbomachine has, in a general direction of outflow of the fluid through this turbomachine, moving from the front to the rear, as is represented diagrammatically by the arrow 9, an air inlet 4, a fan 6, and a flow separation nozzle 14, from which emerge an annular primary channel 16 and an annular secondary channel 18, the latter being positioned radially towards the outside relative to the primary channel 16. These traditional elements known to the skilled man in the art each naturally are annular in shape, and are centred on a longitudinal axis 22 of the turbomachine.

Thus, the air flow F traversing fan 6 is divided into two separate flows after it comes into contact with the upstream end of separation nozzle 14, namely into a primary flow F1 entering channel 16, and a secondary flow F2 entering channel 18.

In addition, fan 6 is surrounded by a fan casing 24 extended downstream by an outer ferrule 28 of an intermediate casing 26, attached to casing 24 by means of bolts. Intermediate casing 26 also has, positioned concentrically and radially towards the interior relative to ferrule 28, a hub 30 centred on axis 22 and located downstream from flow separation nozzle 14.

Structural connecting arms 32 provide the mechanical connection between ferrule 28 and hub 30, these arms being spaced circumferentially relative to one another, in regular fashion, and each extending roughly in the radial direction of the turbojet. Structural arms 32 therefore have a high mechanical resistance, allowing firstly the efforts between ferrule 28 and hub 30 to be transmitted, and secondly allowing the projectiles likely to impact it to be able to be resisted.

In addition, each arm 32 traversing secondary channel 18 has an aerodynamic outer surface 36 shaped such that the arm also performs the function of an outlet guide vane, or OGV, the aim of which is to straighten the secondary air flow F2 escaping from fan 6, in order to limit its whirling.

Consequently, there is no requirement for additional outlet guide vanes to be interposed between fan 6 and structural arms 32, and the latter then constitute the first elements which the air of secondary flow F2 traverses after going beyond separation nozzle 14.

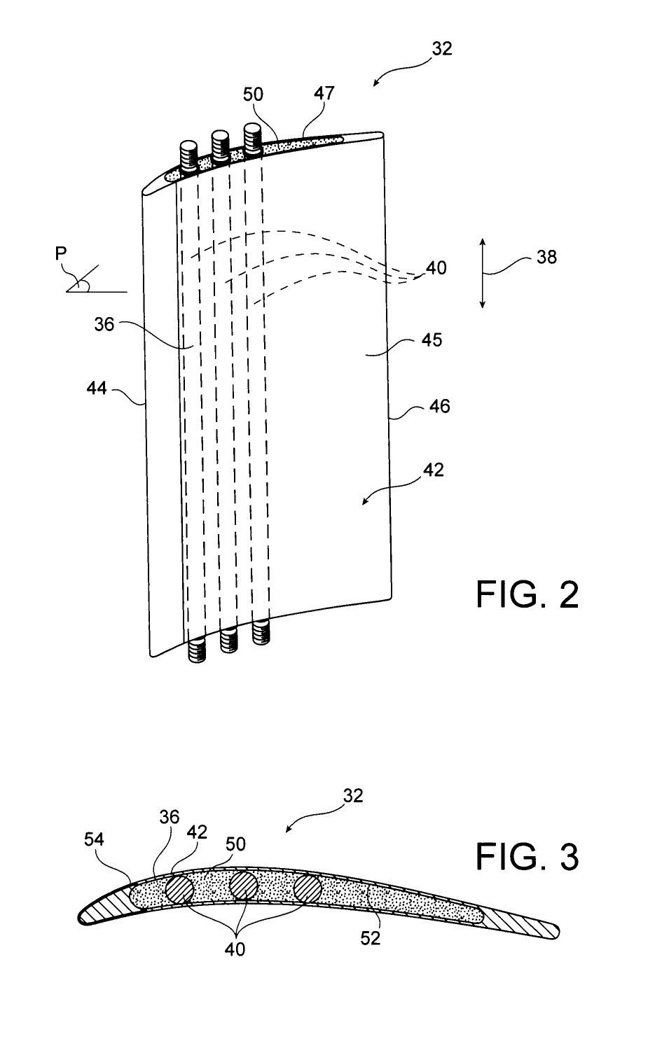

With reference at present FIG. 2, one of the structural connecting arms 32 fitted to the intermediate casing is shown. One of the features of this arm lies in the fact that the elements used to perform the mechanical function are disassociated from those used to perform the aerodynamic function of straightening of the flow. Indeed, to perform the mechanical resistance function, arm 32 includes multiple metal ties which extend in the longitudinal direction of the arm, schematised by double arrow 38. There are, for example, three such ties 40, spaced relative to one another according to the structure of the arm forming the outlet guide vane.

As mentioned above, the longitudinal direction 38 in this case is the radial direction of the turbojet on which arm 32 is intended to be installed. Moreover, it is noted that each arm of the intermediate casing has a design comparable to the one described here.

To perform the aerodynamic function of straightening of the secondary flow, the arm has a shell 42 made from composite material, preferably of the type of glass and/or carbon fibres with a resin, for example an epoxy resin. This shell therefore takes the shape of a continuous structure, produced using several folds, and forming the leading edge 44 of the arm, the concave side 45, the trailing edge 46, and the convex side 47. Thus, shell 42 defines the entire outer aerodynamic surface 36 of the arm forming the outlet guide vane.

As can best be seen in FIG. 3, the support on which the entire inner surface of shell 42 preferably rests is a filling material 50 filling an inner space 52 demarcated by this same shell, and also traversed by ties 40. In this case, the segments of the ties which traverse shell 42 are completely sunken in this filling material 50, so as to separate these ties from the shell, and thus to prevent a direct contact between these elements, which might cause a floating of the shell during operation of the turbojet. In addition, as can be seen in FIG. 3, this enables a uniform and continuous surface to be presented for the support of the shell, a surface which thus proves to be perfectly suitable for the manufacture by moulding of this same shell made of composite material. In this preferred embodiment, the inner space 52 demarcated by the inner surface of shell 42 is completely filled by filling material 50 and ties 40.

Lastly in the area of the leading edge of shell 42, a foil of material 54 is positioned externally, used to strengthen the mechanical rigidity of the arm, and thus suitable to resist any impacts which the latter might incur.

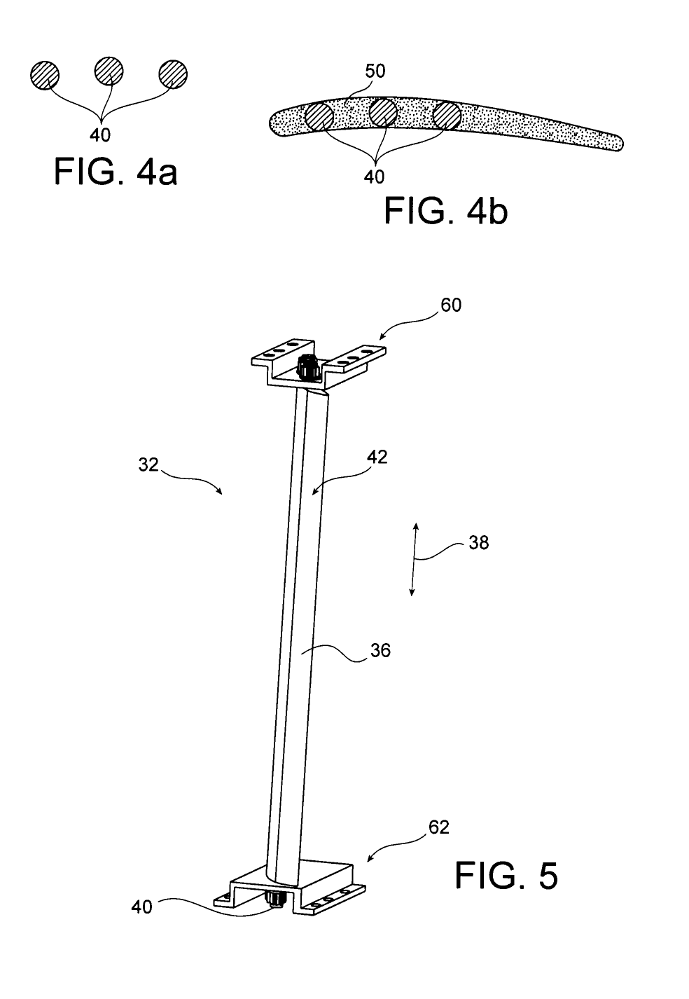

With reference at present FIGS. 4a and 4b, a method of manufacture of the structural arm 32 described above is schematised. Firstly with reference to FIG. 4a, the first operation consists in putting in position ties 40, for example in an appropriate mould (not represented), by positioning them relative to one another in positions such as those adopted in the finalised arm. The filling material is then injected into the abovementioned mould, so as to sink metal ties 40 in a manner set out above, the aim being to cover the entire lateral surface of the tie segments intended to be surrounded by the shell produced subsequently. This involves, for example, injection moulding of expanded foam, or again of any other elastomer judged appropriate by the skilled man in the art. Be that as it may, this filling material 50 is chosen such that it has a low density, such that structural arm 32 has a lower mass.

When the assembly has been obtained, including filling material 50 and ties 40 which are sunk in it, as shown in FIG. 4b, this assembly placed is once again in another mould in which the composite material folds cover filling material 50, before the firing operation the purpose of which is to obtain shell 42. The foil 54 is positioned in this same mould, in order that it adheres to the shell during the said firing. In this case, the composite material folds intended to form shell 42 rest entirely on the outer surface of filling material 50, which therefore forms a uniform and continuous surface along a closed line.

For this moulding, any technique known to the skilled man in the art may be used, such as that known as vacuum injection, also called RTM (Resin Transfer Moulding). At the end of this firing operation arm 32 as shown in FIG. 3 is obtained.

In the preferred embodiment, each tie 40 extends beyond shell 42 in direction 38, as can be seen in FIG. 2. Thus, ties 40 have radially outer ends protruding from filling material 50 and from shell 42; there are also radially inner ends, which also protrude from both these elements. In FIG. 5, it is shown that the radially outer ends are designed to support the means 60 intended to attach the arm on the outer ferrule of the intermediate casing, whereas the radially inner ends are designed to support the means 62, roughly similar to means 60, and intended to attach the arm on the hub of the intermediate casing.

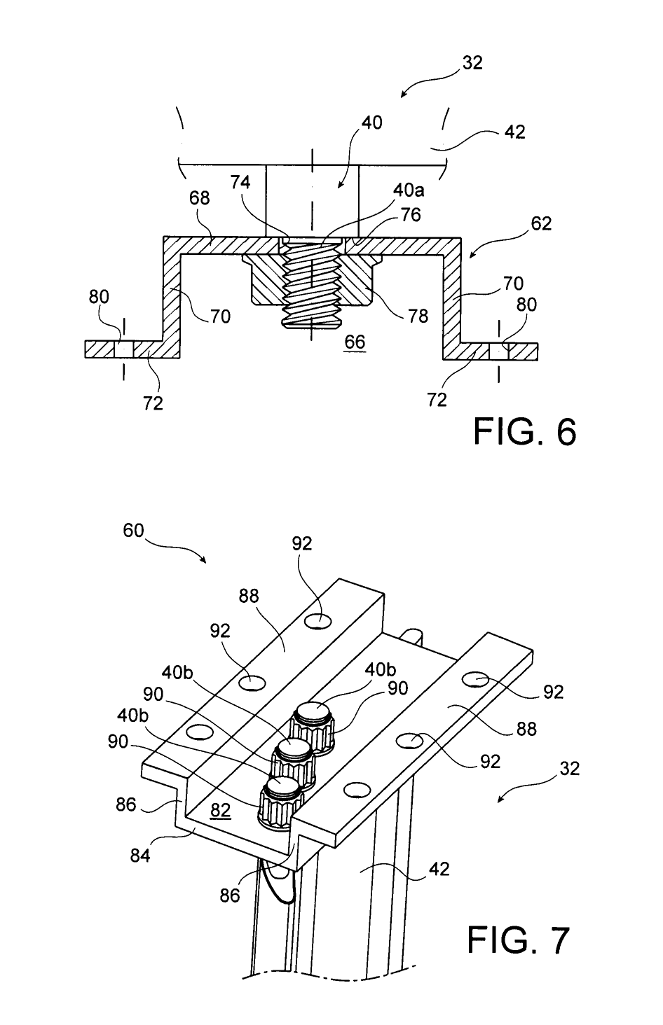

FIG. 6 shows a turbojet transverse plane section of the radially inner part of arm 32. Thus, it can be seen that means 62 have an omega-shaped section, with the hollow 66 of this omega defined jointly by a central face 68 and two lateral faces 70, from which protrude two bases 72 forming the base of the omega. Holes 74 traversed by the radially inner end 40a of ties 40, respectively, are present in the central face 68. Moreover, each end 40a has a shoulder 76 resting on central face 68, the mechanical attachment being provided by a nut 78 housed in the inner space 66 of the omega, and screwed on to end 40a such that it is pressed against the inner surface of central face 68. To facilitate the assembly of arm 72 on the hub, as will be explained below, end 40a and nut 78 remain housed in inner space 66, such that they do not protrude beyond bases 72, each of which also have several attachment holes 84 for assembling the arm on the hub.

There is a comparable configuration for means 60, the bracket of which also has the shape of an inverted omega, with an inner space 82 demarcated jointly by a central face 84 and two lateral surfaces 86, from which two bases 88 emerge forming the base of this inverted omega. In this case too, the radially outer ends 40b of the ties are assembled on central face 84 using nuts 90, which are pressed against central face 84, which has holes for attaching the ties. Each of both bases 88 also has attachment holes 92 for assembling the arm on the outer ferrule of the intermediate casing.

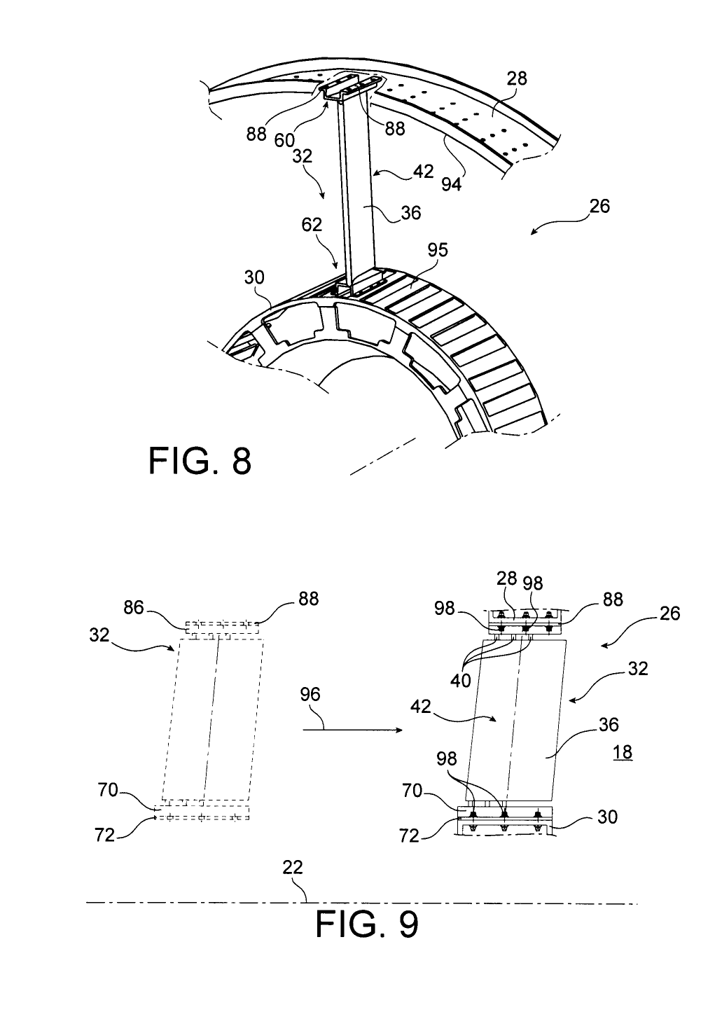

This is notably represented in FIG. 8, showing one of structural arms 32, the means 60 of which have both its bases 88 resting on the inner radial surface 94 of the outer ferrule 28 of the intermediate casing 26, and the bases 72 of the means 62 of which are resting on the outer radial surface 95 of hub 30. In both cases, these bases 72, 88 are joined to the surfaces with which they are in contact by means of screwed elements traversing orifices 80, 92, and co-operating with means of the nut type, which have, for example, previously been secured to ferrule 28 and to hub 30.

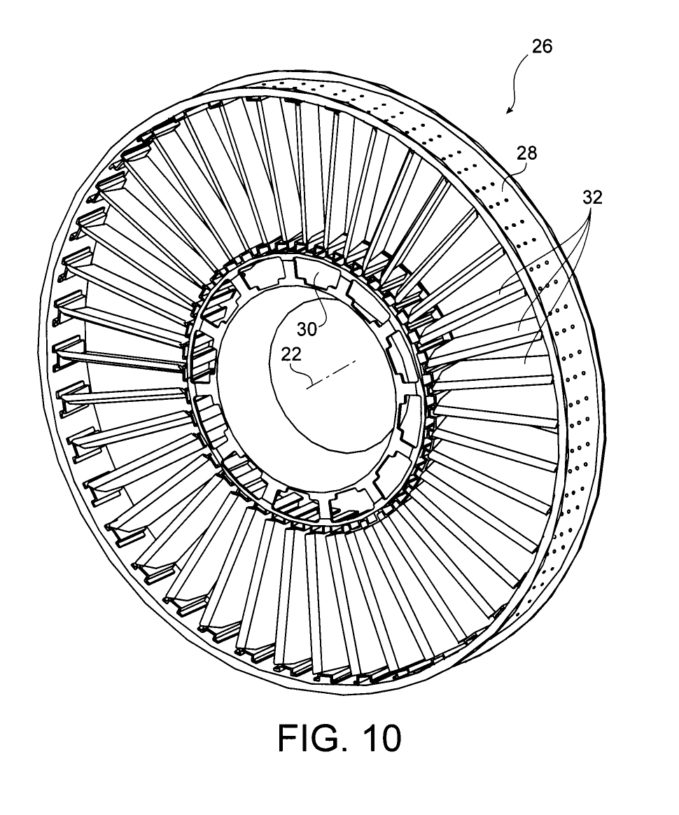

By virtue of the original design of the fastenings 60, 62, the method of assembly of structural arm 32 on the intermediate casing proves extremely simple to accomplish. The preferred manner of such a method is shown in FIG. 9, schematising by dotted lines the positioning of arm 32 opposite annular space 18, demarcated between outer ferrule 28 and hub 30, where both these elements occupy their definitive positions within intermediate casing 26. After this, as is schematised by arrow 96, arm 32 is put in position between ferrule 28 and hub 30, by moving it in the axial direction of arrow 96, parallel to axis 22 of the turbojet and of the intermediate casing. During this movement, bases 88 slide over inner surface 94 of ferrule 28, while bases 72 simultaneously slide over outer surface 95 of hub 30, until the final position of this arm within casing 26 is reached.

After this, bases 88, 72 are attached to ferrule 28 and hub 32 using screwed elements as described above, and represented here schematically with the elements referenced 98. With this configuration, the assembly of an arm 32, and also its disassembly, are extremely easy, making it possible for it to be an item of equipment which can easily be replaced during a stopover. In addition, the easy character of the assembly and disassembly is accentuated by the fact that screwed elements 98 can be assembled and disassembled by an operator from annular space 18, without requiring additional access in the area of ferrule 28 or hub 30.

Naturally, arms 32 can be assembled one after another in the manner which has just been described above, in order to accomplish intermediate casing 26 shown in FIG. 10.

Naturally, various modifications can be made by the skilled man in the art to the invention which has just been described, solely as non-restrictive examples.

1-9. (canceled)

10. A structural connecting arm for an intermediate casing of an aircraft turbomachine with a ducted fan, wherein the arm is configured to connect a hub and an outer ferrule of the intermediate casing, and comprising:
an aerodynamic outer surface manufactured such that the arm also forms an outlet guide vane;
multiple metal ties extending in a longitudinal direction of the arm, together with a shell made from a composite material surrounding the ties and forming the aerodynamic outer surface; and
wherein at least one part of an inner space demarcated by the shell and traversed by the ties is filled by a filling material forming a support of the shell.

11. A structural arm according to claim 10, wherein each tie is separated from the shell made from composite material by the filling material.

12. A structural arm according to claim 11, wherein each tie is sunk in the filling material along an entire length of the shell.

13. A structural arm according to claim 10, wherein each tie extends, in the longitudinal direction of the arm, beyond the shell, on either side of the shell.

14. A structural arm according to claim 10, wherein the ties support at their radially outer ends means for attaching the arm on the outer ferrule of the intermediate casing, and support at their radially inner ends means for attaching the arm on the hub of the intermediate casing.

15. A structural arm according to claim 14, wherein the means for attaching the arm on the outer ferrule and the means for attaching the arm on the hub include a bracket having holes for attaching the ties, and attachment holes for assembly on the outer ferrule and the hub, respectively.

16. An intermediate casing of an aircraft turbomachine with a ducted fan, including multiple structural connecting arms according to claim 10, connecting the hub and the outer ferrule of the casing.

17. An aircraft turbomachine with ducted fan, including an intermediate casing according to claim 16, assembled securely on a fan casing downstream from the fan casing.

18. A method of assembly of a structural connecting arm according to claim 10, on an intermediate casing of an aircraft turbomachine with ducted fan, comprising:
positioning of the arm facing the annular space demarcated between the outer ferrule and the hub of the intermediate casing;
positioning of the arm between the outer ferrule and the hub of the intermediate casing, by moving the arm in the axial direction of the intermediate casing; and
attaching the arm on the outer ferrule and on the hub of the intermediate casing.
